(19) United States
(12) Patent Application Publication
(10) Pub. No.: US 2015/0162655 A1
(43) Pub. Date: Jun. 11, 2015

(54) Terminal Having Multimode Antenna

(71) Applicant: Huawei Device Co., Ltd., Shenzhen (CN)

(72) Inventors: Chen Zhang, Xi'an (CN); Bing Liu, Xi'an (CN)

(73) Assignee: HUAWEI DEVICE CO., LTD., Shenzhen (CN)

(21) Appl. No.: 14/584,886

(22) Filed: Dec. 29, 2014

Related U.S. Application Data
(63) Continuation of application No. PCT/CN2014/084494, filed on Aug. 15, 2014.

(30) Foreign Application Priority Data
Dec. 6, 2013 (CN) 201310656743.X

(51) Int. Cl. H01Q 1/24; H01Q 21/30; H01Q 9/04

(52) U.S. Cl. CPC H01Q 1/243; H01Q 9/0407; H01Q 21/30

(57) ABSTRACT

A terminal having a multimode antenna includes a housing, a printed circuit board, a printed antenna, a flexible printed circuit FPC antenna, and a control circuit, where: the printed circuit board is disposed inside the housing; the printed antenna is disposed on the printed circuit board, the printed antenna is electrically connected to the control circuit, and the printed antenna is configured to implement first antenna performance; the FPC antenna is disposed on the housing, the FPC antenna is electrically connected to the control circuit, and the FPC antenna is configured to implement second antenna performance; and the control circuit is disposed on the printed circuit board, and the control circuit is configured to control the printed antenna and the FPC antenna to receive or send an antenna signal.

This application is a continuation of International Application No. PCT/CN2014/084494, filed on Aug. 15, 2014, which claims priority to Chinese Patent Application No. CN 201310656743.X, filed on Dec. 6, 2013, both of which are hereby incorporated by reference in their entireties.

### TECHNICAL FIELD

The present invention relates to the field of antennas, and in particular, to a terminal having a multimode antenna.

### BACKGROUND

With fast development of mobile communications technologies, and based on market demands, a terminal product needs to support networks in different frequency bands such as 2G, 3G, and 4G at the same time, and this requires larger antenna bandwidth. In addition, miniaturization is also an important evaluation criterion for quality of a terminal product in the consumer market.

As an antenna that can be printed on a printed circuit board (PCB), a printed antenna has advantages of a small volume and simple fabrication process, and conforms to the requirement of terminal product miniaturization. However, a gain of the printed antenna is small, and therefore larger antenna bandwidth cannot be achieved.

### SUMMARY

Embodiments of the present invention provide a terminal having a multimode antenna, which can meet both a requirement of larger antenna bandwidth and a requirement of product miniaturization.

In accordance with an embodiment, a terminal having a multimode antenna is provided. In this example, the terminal comprises a housing, a printed circuit board disposed inside the housing, a printed antenna disposed on the printed circuit board, a flexible printed circuit (FPC) antenna disposed on the housing, and a control circuit disposed on the printed circuit board. The printed antenna is configured to implement first antenna performance, and the FPC antenna is configured to implement second antenna performance. The printed antenna and the FPC antenna are electrically connected to the control circuit, and the control circuit is configured to control the printed antenna and the FPC antenna to receive or send an antenna signal.

In accordance with another embodiment, another terminal having a multimode antenna is provided. In this example, the terminal comprises a housing, a printed circuit board disposed inside the housing, a printed antenna disposed on the printed circuit board, a flexible printed circuit (FPC) antenna disposed on the housing, and a control circuit disposed on the printed circuit board. The printed antenna is configured to implement first antenna performance, and the FPC antenna is configured to implement second antenna performance. The printed antenna and the FPC antenna are electrically connected to the control circuit, and the control circuit is configured to control the printed antenna and the FPC antenna to receive or send an antenna signal. The FPC antenna is electrically connected to the control circuit by at least one electrical connecting element. The electrical connection between the FPC antenna and the control circuit id separable.

According to a first aspect, a terminal having a multimode antenna includes a housing, a printed circuit board, a printed antenna, a flexible printed circuit FPC antenna, and a control circuit, where: the printed circuit board is disposed inside the housing; the printed antenna is disposed on the printed circuit board, the printed antenna is electrically connected to the control circuit, and the printed antenna is configured to implement first antenna performance; the FPC antenna is disposed on the housing, the FPC antenna is electrically connected to the control circuit, and the FPC antenna is configured to implement second antenna performance; and the control circuit is disposed on the printed circuit board, and the control circuit is configured to control the printed antenna and the FPC antenna to receive or send an antenna signal.

With reference to the first aspect, in a first possible implementation manner, that the FPC antenna is electrically connected to the control circuit includes that: the FPC antenna is electrically connected to the control circuit by using at least one electrical connecting element.

With reference to the first aspect or the first possible implementation manner of the first aspect, in a second possible implementation manner, the electrical connecting element includes: an elastic connecting element.

With reference to the first aspect or either of the foregoing possible implementation manners, in a third possible implementation manner, that the FPC antenna is electrically connected to the control circuit includes that: the electrical connection between the FPC antenna and the control circuit is separable.

With reference to the first aspect or any one of the foregoing possible implementation manners, in a fourth possible implementation manner, the FPC antenna includes an FPC antenna body and an FPC antenna terminal, where the FPC antenna body is disposed on an outer surface of the housing, and the outer surface of the housing deviates from the printed circuit board; and the FPC antenna terminal is disposed on an inner surface of the housing, and is connected to the FPC antenna body by using a through hole of the housing, and the FPC antenna terminal is configured to electrically connect to the control circuit.

With reference to the first aspect or any one of the foregoing possible implementation manners, in a fifth possible implementation manner, the printed antenna is disposed on a first surface of the printed circuit board, the electrical connecting element is disposed on a second surface of the printed circuit board, and the first surface and the second surface are two opposite surfaces.

With reference to the first aspect or any one of the foregoing possible implementation manners, in a sixth possible implementation manner, that the printed antenna is electrically connected to the control circuit includes that: the printed antenna is electrically connected to the control circuit by using at least one detachable CHIP FIXED resistor.

With reference to the sixth possible implementation manner, in a seventh possible implementation manner, the at least one detachable CHIP FIXED resistor is disposed at at least one matching position of the printed circuit board, and the printed antenna implements feeding or grounding by using the matching position.

With reference to the seventh possible implementation manner, in an eighth possible implementation manner, the at least one matching position can be switched on or offswitching or off, so that the printed antenna works in at least one of the following forms: Monopole, Inverted-F, Monopole+parasitic, IFA+parasitic, and LOOP.

With reference to the first aspect or any one of the foregoing possible implementation manners, in a ninth possible implementation manner, the first antenna performance is high-frequency antenna performance, and the second antenna performance is low-frequency antenna performance; or, the first antenna performance is low-frequency antenna performance, and the second antenna performance is high-frequency antenna performance.

In a terminal having a multimode antenna provided by the embodiments of the present invention, a printed antenna is disposed on a printed circuit board, an FPC antenna is disposed on a housing of the terminal, and the foregoing two antennas implement different antenna performance, so that the terminal device has larger bandwidth; and the FPC antenna uses an area of the housing of the terminal, and does not need to occupy an area of the printed circuit board, which can effectively reduce a size of the terminal.

### BRIEF DESCRIPTION OF THE DRAWINGS

To describe technical solutions in embodiments of the present invention more clearly, the following briefly introduces accompanying drawings required for describing the embodiments of the present invention. Apparently, the accompanying drawings in the following description show merely some embodiments of the present invention, and a person of ordinary skill in the art may still derive other drawings from these accompanying drawings without creative efforts.

FIG. 1 is a schematic diagram of local decomposition of a terminal having a multimode antenna according to an embodiment of the present invention;

FIG. 2 is a schematic framework diagram of a terminal according to an embodiment of the present invention;

FIG. 3 is a schematic diagram of a matching position of a printed antenna according to an embodiment of the present invention;

FIG. 4 is a schematic diagram of another matching position of a printed antenna according to an embodiment of the present invention;

FIG. 5 is a schematic diagram of still another matching position of a printed antenna according to an embodiment of the present invention;

FIG. 6 is a schematic diagram of a arrangement of a printed antenna and an FPC antenna of a terminal according to an embodiment of the present invention; and

FIG. 7 is a schematic diagram of an elastic connecting element according to an embodiment of the present invention.

### DETAILED DESCRIPTION OF ILLUSTRATIVE EMBODIMENTS

The following clearly describes technical solutions in embodiments of the present invention with reference to accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present invention.

The embodiments of the present invention relate to a terminal 100 having a multimode antenna, where the terminal 100 may be a mobile phone, a tablet computer, a wireless network device, or the like.

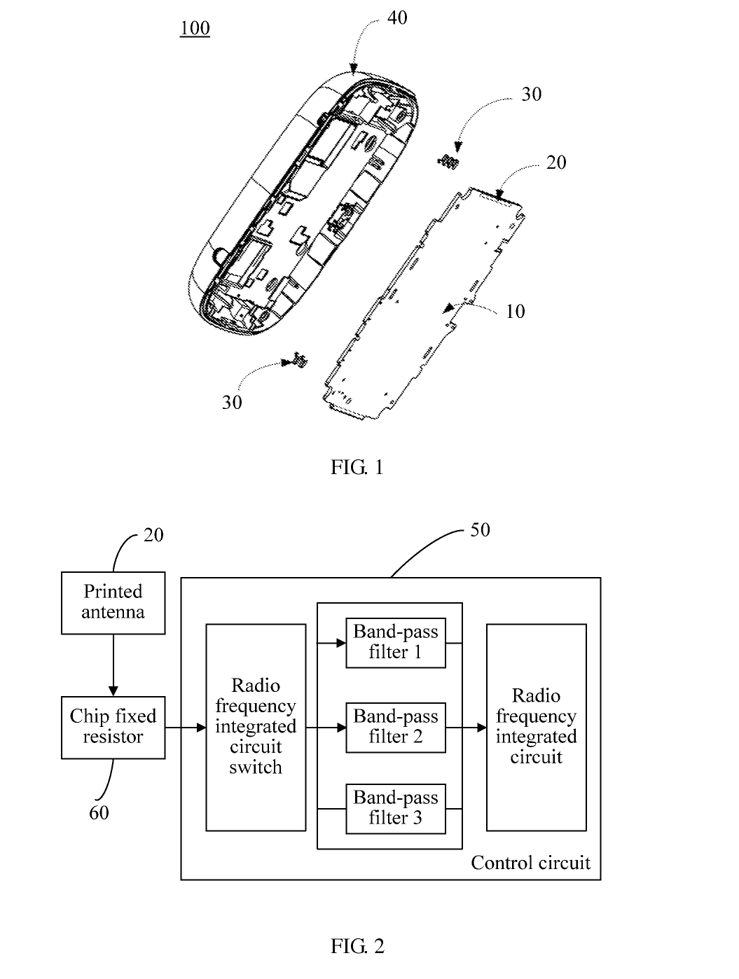

FIG. 1 is a schematic diagram of local decomposition of the terminal 100 having a multimode antenna according to an embodiment of the present invention.

This embodiment of the present invention relates to the terminal 100, including: a printed circuit board 10, a printed antenna 20, a flexible printed circuit FPC antenna 40, a control circuit 50, and a housing 70, where the printed circuit board 10 is disposed inside the housing 70;

the printed antenna 20 is disposed on the printed circuit board 10, the printed antenna 20 is electrically connected to the control circuit 50, and the printed antenna 20 is configured to implement first antenna performance;

the FPC antenna 40 is disposed on the housing 70, the FPC antenna 40 is electrically connected to the control circuit 50, and the FPC antenna 40 is configured to implement second antenna performance; and

the control circuit 50 is disposed on the printed circuit board 10, and the control circuit 50 is configured to control the printed antenna 20 and the FPC antenna 40 to receive or send an antenna signal.

In the terminal 100 having a multimode antenna provided by this embodiment of the present invention, a printed antenna 20 is disposed on a printed circuit board 10, an FPC antenna 40 is disposed on a housing 70 of the terminal, and the foregoing two antennas implement different antenna performance, so that the terminal 100 has larger bandwidth; and the FPC antenna 40 uses an area of the housing 70 of the terminal, and does not need to occupy an area of the printed circuit board 10, which can effectively reduce a size of the terminal.

FIG. 2 is a schematic framework diagram of a circuit of a printed antenna of the terminal 100 according to an embodiment of the present invention.

Referring to FIG. 2, that the printed antenna 20 is electrically connected to the control circuit 50 includes that: the printed antenna 20 is electrically connected to the control circuit 50 by using at least one detachable CHIP FIXED resistor 60.

When working, the printed antenna 20 is electrically connected to the control circuit 50 by using the detachable CHIP FIXED resistor 60. The at least one detachable CHIP FIXED resistor 60 is disposed at least one matching position of the printed circuit board 10, where the printed antenna implements feeding or grounding by using the matching position.

For example, the CHIP FIXED resistor 60 may be 0 ohm, and a matching position of the CHIP FIXED resistor 60 is reserved at an end of the printed antenna 20, where the number of the matching position may be two. According to user requirements, when the printed antenna 20 is used, the CHIP FIXED resistor 60 is attached to the matching position, to enable an electrical connection between the printed antenna 20 and the control circuit 50. When the printed antenna 20 is not used, the CHIP FIXED resistor 60 is detached from the matching position, to break the electrical connection between the printed antenna 20 and the control circuit 50.

Specifically, referring to FIG. 3, in this embodiment, an example of reserving two matching positions for the printed antenna 20 is used for description, and the two matching positions are respectively a matching position A point and a matching position B point, where the A point is a ground-point matching position, and the B point is a feeding-point matching position of the printed antenna 20. If only the CHIP FIXED resistor 60 at the B point is connected, the printed antenna 20 is fed by using the B point, and may work normally. In this case, a form of the printed antenna is a monopole antenna Monopole. When the chip fixed resistors 60 at the A point and the B point are connected, the printed antenna is fed by using the B point, is grounded by using the A point, and may also work normally. In this case, the form of the printed antenna 20 is an Inverted-F antenna IFA. Reference may be made to Table 1.

TABLE 1

| Matching Position Connection | Antenna Form |
|---|---|
| The A point is disconnected, and the B point is | monopole |
| connected | |
| Both the A point and the B point are connected | IFA |

Optionally, for the terminal 100 of this embodiment, if the FPC antenna 40 is installed, when the matching position B point is connected, the printed antenna 20 and the FPC antenna 40 may work at the same time, and cover low-frequency bandwidth and high-frequency bandwidth; and when B point 0 ohm is disconnected, only the FPC antenna 40 is connected to the control circuit by using an electrical connecting element, so the FPC antenna 40 works independently, and may cover the low-frequency bandwidth. If the FPC antenna 40 is not attached, 0 ohm at the feeding point B point needs to be connected, and the printed antenna may work normally, and may cover the high-frequency bandwidth. In this way, for customers that require different frequency bands, an overall antenna structure does not needs to be designed and manufactured again. By using design of the FPC antenna 40 that is separable and that of the printed antenna 20 that can be switched on or offswitching or off, selection of different antenna combinations and frequency bands may be conveniently implemented during a process of production, manufacturing, or usage, to lower costs.

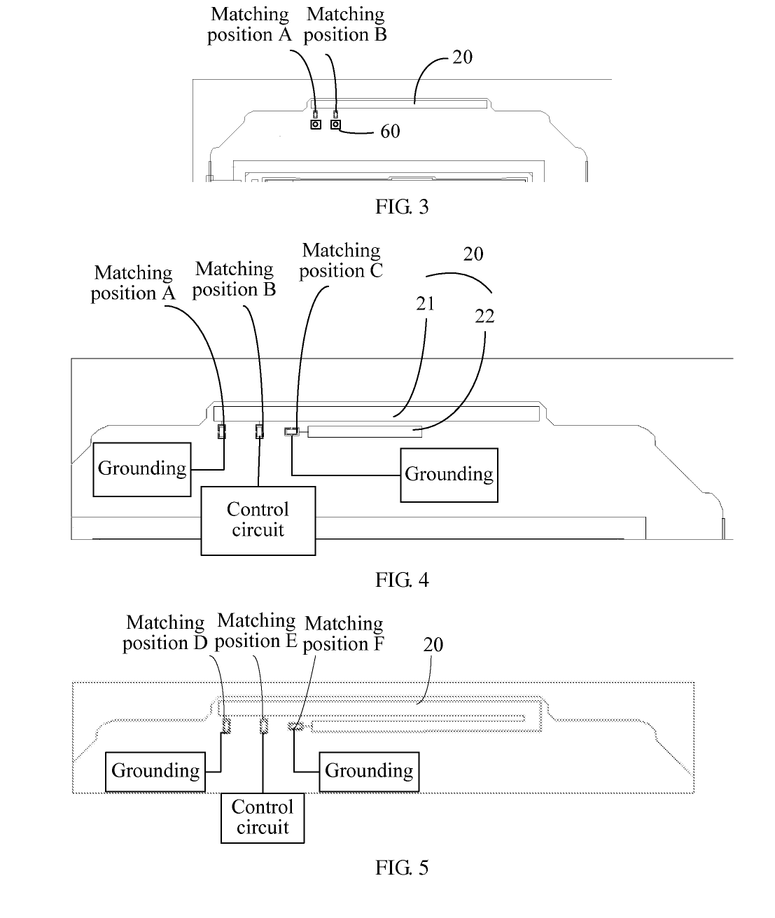

Optionally, an example of reserving three matching positions for the printed antenna 20 is used for further description. As shown in FIG. 4, the printed antenna 20 may include a main portion 21 and a parasitic branch 22, where the main portion 21 may be a monopole sub-antenna, a loop LOOP antenna, or an antenna in another form. The three matching positions are respectively an A point, a B point, and a C point, where the A point and the C point are ground-point matching positions, and the B point is a feeding-point matching position of the printed antenna 20. If only the CHIP FIXED resistor 60 at the B point is connected, the printed antenna 20 is fed by using the B point, the printed antenna 20 may work normally. In this case, a form of the printed antenna is the monopole antenna Monopole.

When the chip fixed resistors 60 at the A point and the B point are connected, the printed antenna is fed by using the B point, and is grounded by using the A point, and the form of the printed antenna 20 is the Inverted-F antenna IFA.

When the chip fixed resistors 60 at the B point and the C point are connected, the printed antenna is fed by using the B point, and is grounded by using the C point, and the form of the printed antenna 20 is a monopole antenna with a parasitic element.

When chip fixed resistors 60 at the A point, the B point, and the C point are all connected, the printed antenna is fed by using the B point, and is grounded by using the A point and the C point, and the form of the printed antenna 20 is an Inverted-F antenna with a parasitic element. Reference may be made to Table 2:

TABLE 2

| Matching Position Connection | Antenna Form |
|---|---|
| The B point is connected | monopole |
| The A point and the B point are connected | IFA |
| The B point and the C point are connected | Monopole + |
| | parasitic |
| The A point, the B point, and the C point are connected | IFA + parasitic |

Optionally, referring to FIG. 5, the printed antenna 20 may further be a loop LOOP antenna, and includes the three matching positions that are respectively a D point, an E point, and an F point, where the D point and the F point are ground-point matching positions, and the E point is a feeding-point matching position of the printed antenna 20. If only the CHIP FIXED resistor 60 at the E point is connected, the printed antenna 20 may work normally. In this case, a form of the printed antenna is the monopole antenna Monopole. When the matching positions at the D point and the E point are connected, the form of the printed antenna 20 is the Inverted-F antenna IFA.

When the chip fixed resistors 60 at the E point and the F point are connected, the form of the printed antenna 20 is the loop LOOP antenna.

When chip fixed resistors 60 at the D point, the E point, and the F point are all connected, the form of the printed antenna 20 is the loop LOOP antenna, where the form of the LOOP antenna formed when chip fixed resistors 60 at the D point, the E point, and the F point are all connected is different from the form of the LOOP antenna formed when the chip fixed resistors 60 at the E point and the F point are connected.

Reference may be made to Table 3:

TABLE 3

| Matching Position Connection | Antenna Form |
|---|---|
| The B point is connected | monopole |
| The A point and the B point are connected | IFA |
| The B point and the C point are connected | LOOP |
| The A point, the B point, and the C point are connected | LOOP |

According to the foregoing combinations of controlling switching-on or off of the at least two matching positions of the printed antenna 20, different cabling forms may be set for the printed antenna 20, to add a type of the printed antenna, expand an application scope of the printed antenna, and improve flexibility of the printed antenna.

It may be understood that, in this embodiment of the present invention, the printed antenna 20 may use high-frequency cabling, and the FPC antenna may use low-frequency cabling; and in another embodiment, the printed antenna 20 may use the low-frequency cabling, and the FPC antenna 40 may use the high-frequency cabling. Sizes and shapes of the printed antenna 20 and the FPC antenna 40 may be set according to a desired frequency band, and this is not limited by this embodiment of the present invention.

It may be understood that, the printed antenna 20 is printed at an edge of the printed circuit board 10, and there is at least one printed antenna. Specifically, the printed antenna 20 may be printed in antenna areas at two ends of the printed circuit board 10. A strip shape is used as an example for the printed antenna in FIG. 5. In another embodiment, a size and a shape of an antenna may be set according to different frequency bands. The printed antenna 20 is a copper leakage area of the printed circuit board 10. It may be further understood that, the printed antenna 20 may be printed on a same side or different sides of the printed circuit board 10.

Further, in this embodiment, the printed antenna 20 may use 1/4 wavelength cabling of a high-frequency required frequency band, to control high-frequency radiation performance of the antenna, and the FPC antenna 40 may use low-frequency 1/4 wavelength cabling, to control low-frequency radiation performance of the antenna.

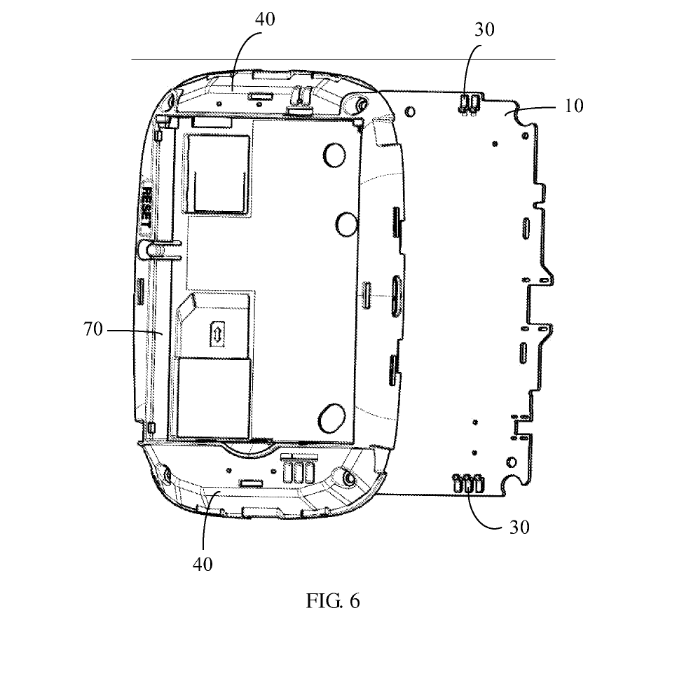

FIG. 6 is a schematic diagram of a layout of an FPC antenna of a terminal according to an embodiment of the present invention.

That the FPC antenna 40 is electrically connected to the control circuit 50 includes that: the FPC antenna 40 is electrically connected to the control circuit 50 by using at least one electrical connecting element. The electrical connecting element includes: an elastic connecting element.

It may be understood that, the electrical connection between the FPC antenna and the control circuit is separable. For example, the FPC antenna 40 presses against the elastic connecting element 30.

The FPC antenna 40 includes an FPC antenna body and an FPC antenna terminal (which are not shown in FIG. 6), where the FPC antenna body is disposed on an outer surface of the housing 70, and the outer surface of the housing 70 deviates from the printed circuit board 10; and the FPC antenna terminal is disposed on an inner surface of the housing 70, and is connected to the FPC antenna body by using a through hole (which is not shown in FIG. 6) of the housing 70, and the FPC antenna terminal is configured to electrically connect to the control circuit 50.

For example, the FPC antenna 40 is pasted on the outer surface of the housing 70; and in another embodiment, the FPC antenna 40 may also be secured by using an antenna bracket, where the housing 70 may be a middle housing of the terminal 100, and the middle housing is secured between the printed circuit board 10 and the housing of the terminal 100, and is configured to protect an electronic element on the printed circuit board 10.

It may be understood that, the FPC antenna 40 may also be secured or pasted at another position according to structure design requirements of different products; and this embodiment of the present invention does not limit a securing manner or a securing position of the FPC antenna 40.

It may be further understood that, a material of the FPC may be copper, a steel sheet, or a laser direct structuring LDS technology.

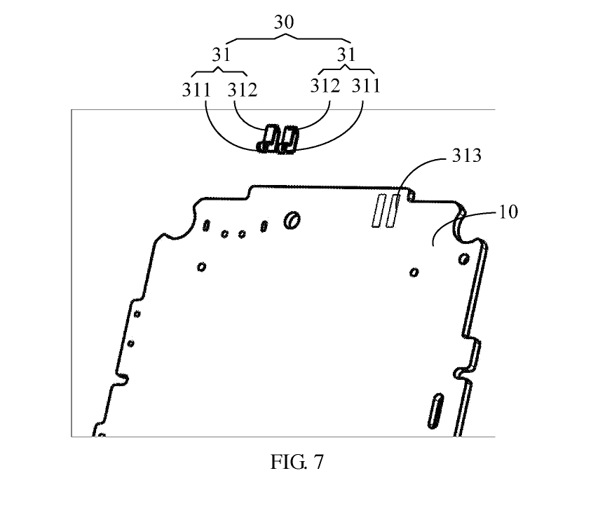

Further, as shown in FIG. 7, the elastic connecting element 30 includes at least two elastic pins 31, each elastic pin 31 includes a contact 311 and a supporting part 312, the contact 311 is configured to press against the FPC antenna, and the supporting part 312 is secured to the printed circuit board 10, where the supporting part 312 may be welded on the printed circuit board 10 by using a pad 313.

The supporting part 312 and the contact 311 are formed integrally, the contact 311 extends and bends along one end of the supporting part 312, the contact 311 is roughly in a U shape, and the supporting part 312 is roughly in a strip shape. In this embodiment, the supporting part 312 and the contact 311 are located on a same plane, and the plane on which the supporting part 312 and the contact 311 are located is roughly perpendicular to a plane on which the printed circuit board 10 is located. The contact 311 is configured to press against or abut against an antenna terminal of the FPC antenna 40, to connect the FPC antenna 40 to a control circuit of the printed circuit board by using the elastic connecting element 30.

A material of the elastic connecting element 30 is a metal material, which may be steel, copper, iron, or the like.

In this embodiment, the printed antenna 20 is disposed on a first surface of the printed circuit board 10, the electrical connecting element 30 is disposed on a second surface of the printed circuit board 10, and the first surface and the second surface are two opposite surfaces.

It may be understood that, the pressing-against that is described in this embodiment of the present invention is seamless pressing-against. The printed antenna 20 and the FPC antenna 40 share same three-dimensional space.

Optionally, a control switch may also be connected in series between the printed antenna 20 and the control circuit 50 if the CHIP FIXED resistor is not used, so that switching on or off between the printed antenna 20 and the control circuit 50 is controlled by controlling switching on or off of the control switch. In another embodiment, the switching or off between the printed antenna 20 and the control circuit 50 may also be controlled in another manner.

The terminal 100 may further include elements such as a display, a processor, a memory, a loudspeaker, and a camera apparatus; and the terminal 100 may be a network device, and may also be a user terminal device, and the number of the included elements may be greater or less than that of those listed above.

In the terminal of this embodiment of the present invention, the FPC antenna 40 is separably connected to the printed circuit board 10 by using the elastic connecting element 30, so that the printed antenna 20 and the FPC antenna 40 separably work, corresponding antennas are set according to different customer requirements, and space and costs are saved while bandwidth is increased.

The present invention is described in detail by referring to the accompanying drawings and with reference to preferred embodiments, but the present invention is not limited thereto. Various equivalent modifications or replacements can be made to the embodiments of the present invention by a person of ordinary skill in the art without departing from the essence of the present invention, and the modifications or replacements shall fall within the scope of the present invention.

What is claimed is:

1. A terminal having a multimode antenna, the terminal comprising:
a housing;
a printed circuit board disposed inside the housing;
a printed antenna disposed on the printed circuit board, wherein the printed antenna is configured to implement first antenna performance;
a flexible printed circuit (FPC) antenna disposed on the housing, wherein the FPC antenna is configured to implement second antenna performance; and
a control circuit disposed on the printed circuit board, wherein the printed antenna and the FPC antenna are electrically connected to the control circuit, and wherein the control circuit is configured to control the printed antenna and the FPC antenna to receive or send an antenna signal.

2. The terminal according to claim 1, wherein that the FPC antenna is electrically connected to the control circuit by at least one electrical connecting element.

3. The terminal according to claim 2, wherein the electrical connecting element comprises an elastic connecting element.

4. The terminal according to claim 1, wherein an electrical connection between the FPC antenna and the control circuit is separable.

5. The terminal according to claim 1, wherein the FPC antenna comprises an FPC antenna body disposed on an outer surface of the housing, and an FPC antenna terminal disposed on an inner surface of the housing, the FPC antenna terminal being connected to the FPC antenna body by a through hole of the housing, and
wherein the FPC antenna terminal is configured to electrically connect to the control circuit.

6. The terminal according to claim 2, wherein the printed antenna is disposed on a first surface of the printed circuit board, wherein the electrical connecting element is disposed on a second surface of the printed circuit board, and wherein the first surface and the second surface are two opposite surfaces.

7. The terminal according to claim 2, wherein the printed antenna is electrically connected to the control circuit by at least one detachable CHIP FIXED resistor.

8. The terminal according to claim 7, wherein the at least one detachable CHIP FIXED resistor is disposed on at least one matching position of the printed circuit board, and
wherein the printed antenna implements feeding or grounding using the at least one matching position.

9. The terminal according to claim 8, wherein the at least one matching position is adapted to be switched on or off such that the printed antenna operates in at least one of a Monopole antenna form, an Inverted-F antenna form, a Monopole+parasitic antenna form, a IFA+parasitic antenna form, and a LOOP antenna form.

10. The terminal according to claim 1, wherein the first antenna performance is high-frequency antenna performance, and the second antenna performance is low-frequency antenna performance.

11. The terminal according to claim 1, wherein the first antenna performance is low-frequency antenna performance, and the second antenna performance is high-frequency antenna performance.

12. A terminal having a multimode antenna, the terminal comprising:
a housing;
a printed circuit board disposed inside the housing;
a printed antenna disposed on the printed circuit board, wherein the printed antenna is configured to implement first antenna performance;
a flexible printed circuit (FPC) antenna disposed on the housing, wherein the FPC antenna is configured to implement second antenna performance; and
a control circuit disposed on the printed circuit board, wherein the printed antenna is electrically connected to the control circuit, wherein the control circuit is configured to control the printed antenna and the FPC antenna to receive or send an antenna signal, and
wherein the FPC antenna is electrically connected to the control circuit by at least one electrical connecting element, the electrical connection between the FPC antenna and the control circuit being separable.

13. The terminal according to claim 12, wherein the electrical connecting element comprises an elastic connecting element.

14. The terminal according to claim 12, wherein the FPC antenna comprises an FPC antenna body disposed on an outer surface of the housing, and an FPC antenna terminal disposed on an inner surface of the housing, the FPC antenna terminal being connected to the FPC antenna body by a through hole of the housing, and
wherein the FPC antenna terminal is configured to electrically connect to the control circuit.

15. The terminal according to claim 12, wherein the printed antenna is disposed on a first surface of the printed circuit board, wherein the electrical connecting element is disposed on a second surface of the printed circuit board, and wherein the first surface and the second surface are two opposite surfaces.

16. The terminal according to claim 12, wherein the printed antenna is electrically connected to the control circuit by at least one detachable CHIP FIXED resistor.

17. The terminal according to claim 16, wherein the at least one detachable CHIP FIXED resistor is disposed on at least one matching position of the printed circuit board, and
wherein the printed antenna implements feeding or grounding using the at least one matching position.

18. The terminal according to claim 17, wherein the at least one matching position is adapted to be switched on or off such that the printed antenna operates in at least one of a Monopole antenna form, an Inverted-F antenna form, a Monopole+parasitic antenna form, a IFA+parasitic antenna form, and a LOOP antenna form.

19. The terminal according to claim 12, wherein the first antenna performance is high-frequency antenna performance, and the second antenna performance is low-frequency antenna performance.

20. The terminal according to claim 12, wherein the first antenna performance is low-frequency antenna performance, and the second antenna performance is high-frequency antenna performance.
